(19) United States
(12) Patent Application Publication
(10) Pub. No.: US 2025/0283857 A1
(43) Pub. Date: Sep. 11, 2025

(54) AUTOMATIC DETECTION METHOD FOR 3D PIPE WELDING DEFECTS BASED ON PHASED ARRAY ULTRASONIC TESTING

(71) Applicant: SHANTOU ULTRASONIC TESTING TECHNOLOGY CO., LTD., Shantou (CN)

(72) Inventors: Delai LI, Shantou (CN); Jingfeng GUO, Shantou (CN); Qi ZHAO, Shantou (CN); Zhishu JI, Shantou (CN); Jiangtao HU, Shantou (CN); Yinan HUANG, Shantou (CN); Jianghao REN, Shantou (CN); Pingping LIN, Shantou (CN); Xinyu MA, Shantou (CN)

(73) Assignee: SHANTOU ULTRASONIC TESTING TECHNOLOGY CO., LTD., Shantou (CN)

(21) Appl. No.: 18/929,374

(22) Filed: Oct. 28, 2024

Related U.S. Application Data
(63) Continuation of application No. PCT/CN2024/080902, filed on Mar. 11, 2024.

(30) Foreign Application Priority Data
Mar. 11, 2024 (CN) 202410270173.9

(51) Int. Cl. G01N 29/40

(52) U.S. Cl. CPC G01N 29/40

(57) ABSTRACT

An automatic detection method for 3D pipe welding defects based on phased array ultrasonic testing adopts the following technical solution: after initial data are preliminarily filtered by setting a threshold to obtain all suspected defect ranges, all extreme-value regions are obtained through high point expansion and segmentation respectively. Filtering is carried out on the extreme-value regions by setting a threshold, and final defects are merged and automatically measured to obtain the final output data. The method has the benefits that the experience of inspectors is not required throughout the process. The detection of pipe welds is fully automated with the setting of several parameters according to requirements, improving the testing efficiency of pipe welds effectively.

### CROSS-REFERENCE TO RELATED APPLICATIONS

The present application is a continuation application of International Application No. PCT/CN2024/080902, filed on Mar. 11, 2024, which claims priority to Chinese Patent Application No. 202410270173.9, filed on Mar. 11, 2024. All of the aforementioned applications are incorporated herein by reference in their entireties.

### TECHNICAL FIELD

The application relates to the field of ultrasonic testing, in particular to an automatic detection method for three-dimensional (3D) pipe welding defects based on phased array ultrasonic testing (PAUT).

### BACKGROUND

Phased array ultrasonic testing (PAUT) can realize 3D detection of pipe welding defects, which accurately and efficiently detects, locates and classifies defects in pipe welds. In the existing PAUT of pipe welding defects, false defects cannot be avoided. In the existing processing method, the experienced inspectors manually screen and filter according to the testing data and images, which not only has low efficiency, but also need high professional and experience requirements for inspectors, which seriously affects the testing efficiency.

### SUMMARY

The application aims to provide an automatic detection method for 3D pipe welding defects based on phased array ultrasonic testing, specifically provides a method capable of filtering and screening 3D data of pipe welds obtained by PAUT and automatically marking and classifying defect regions of pipe welds.

In order to achieve the above objective, the follow technical solution is adopted with the following steps:
S01, using phased array to detect pipe welds and obtaining original 3D data of the welds;
S02, setting a threshold to preliminarily filter the original 3D data to obtain the range of all suspected defects, which are recorded as F1;
S03, selecting all high points in the suspected defect range F1 as seed points for expansion and segmentation to obtain all extreme value regions, which are recorded as R1;
S04, setting another threshold to filter the region where the extreme values greater than or equal to the threshold in the extreme value region R1 are further processed using the −6 dB method, the region where the extreme values of the extreme values region R1 is smaller than the threshold is not processed, so as to obtain the filtered extreme region R2; and
S05, merging the filtered extreme value regions R2 to obtain a final defect, which is recorded as F3 with measuring the final defect F3 to obtain the final output data D.

Specifically, in step S05 above, when merging the filtered extreme value regions R2, the following steps are adopted:
S51, firstly merging the regions having adjacent relationships in R2 for the first time to obtain suspected defects, which are recorded as F2; and
S52, merging the suspected defects F2 with the distance less than the set value for the second time to obtain the final defect F3.

Specifically, in step S03 above, all the high points of all suspected defects F1 are obtained by the following step:
S31, segmenting F1 into a plurality of 3D unit regions by using 3D units of a set size to acquire all high points by obtaining extreme points in all 3D unit regions, which are recorded as P1.

The method has the beneficial effects that after initial data are preliminarily filtered by setting a threshold to obtain all suspected defect ranges, and all extreme-value regions are obtained through high point expansion and segmentation respectively. The filtering is carried out on the extreme-value regions by setting another threshold, and final defects are merged and automatically measured to obtain the final output data. The experience of inspectors is not required throughout the process. Automatic detection of pipe welds is achieved only by setting relevant parameters according to requirements, improving the testing efficiency of pipe welds effectively.

### BRIEF DESCRIPTION OF THE DRAWINGS

FIG. 1 illustrates a flow chart of pipe defect testing.

### DETAILED DESCRIPTION OF THE EMBODIMENTS

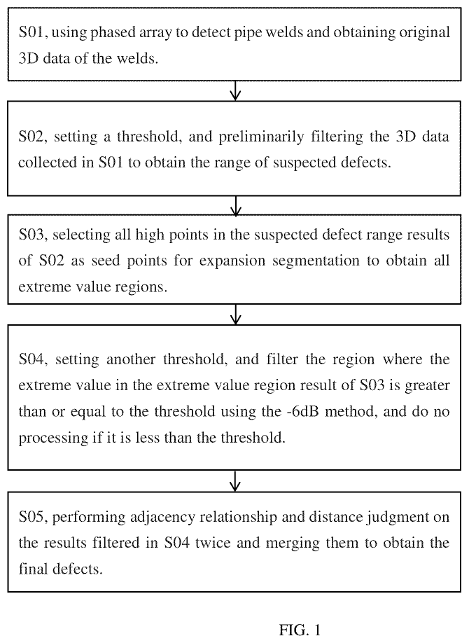

Embodiment 1, referring to FIG. 1, is a phased array based 3D pipe welding defect automatic detection method with the following steps:
S01, using phased array to detect pipe welds and obtaining original 3D data of the welds;
S02, setting a threshold to preliminarily filter the original 3D data to obtain the range of all suspected defects, which are recorded as F1;
S03, selecting all high points in the suspected defect range F1 as seed points for expansion and segmentation to obtain all extreme value regions, which are recorded as R1;
S04, setting another threshold to filter the region where the extreme values greater than or equal to the threshold in the extreme value region R1 using the −6 dB method, the region where the extreme values of the extreme values region R1 is smaller than the threshold is not processed, so as to obtain the filtered extreme region R2; and
S05, merging the filtered extreme value regions R2 to obtain a final defect, which is recorded as F3, and measuring the final defect F3 to obtain the final output data D, wherein the following steps are adopted for merging.

Specifically, in step S05 above, when merging the filtered extreme value regions R2, the following method is specifically adopted for merging:
S51, firstly merging the regions having adjacent relationships in R2 for the first time to obtain suspected defects, which are recorded as F2; and
S52, merging the suspected defects F2 with the distance less than the set value for the second time to obtain the final defect F3.

In the second merger, merging can be carried out according to the merger rule. The setting above values can also be adjusted as actual needs, which are not restricted here. Correspondingly, in the actual product operation process, select the set value by setting the related user interface, and choose whether to merge according to the merger rule of the standard according to the practical user requirements.

Specifically, in step S03 above, all high points in all suspected defect range F1 are obtained by the following step:
S31, segmenting F1 into a plurality of 3D unit regions by using 3D units of a set size, and acquiring all high points by obtaining extreme points in all 3D unit regions, which are recorded as P1.

In addition, it should be noted that in step S03, when expanding and segmenting all the high points, the main flow includes: filtering and binarizing the original 3D data to obtain a set of binary data, then calculating distance transform data with high points as seed points, wherein the distance transform data is calculated based on the distance between each foreground point and the nearest background point in the binary data, and this distance is the gray value at the high point; then calculating gradient data obtained by applying Sobel and Prewitt operators to the aforementioned distance transformation data, which reflects the boundary information of defects in the data, that is the change rate of pixel values in vertical and horizontal directions, multiplying the distance transform data and the gradient data to obtain a new data, and performing threshold processing on the new data to obtain an extreme value region after expansion and segmentation.

Certainly the embodiments above are preferred for the present application only, but not intended to restrict the scope of use of the present application. Therefore, any equivalent changes made on the principles of the present application should be included in the protection scope of the present application.

What is claimed is:

1. An automatic detection method for 3D pipe welding defects based on phased array ultrasonic testing, comprising following steps:
S01, using phased array to detect pipe welds and obtaining original 3D data of welds;
S02, setting a threshold to preliminarily filter the original 3D data to obtain a range of all suspected defects, which are recorded as F1;
S03, selecting all high points in the suspected defect range F1 as seed points for expansion and segmentation to obtain all extreme value regions, which are recorded as R1;
wherein all high points in all suspected defect range F1 are obtained by the following steps:
S31, segmenting F1 into a plurality of 3D unit regions by using 3D units of a set size, and acquiring all high points by obtaining extreme points in all 3D unit regions, which are recorded as P1;
wherein when all the high points in the suspected defect range F1 are used as seed points for expansion and segmentation, the following steps are adopted:
S32, filtering and binarizing the original 3D data to obtain a set of binary data, then calculating distance transform data with high points as seed points, wherein the distance transform data is calculated based on a distance between each foreground point and a nearest background point in the binary data, and this distance is a gray value at the high point; then calculating gradient data which reflects the boundary information of defects in the data, that being a change rate of pixel values in vertical and horizontal directions, multiplying the distance transform data and the gradient data to obtain new data, and performing threshold processing on the new data to obtain an extreme value region after expansion and segmentation;
S04, setting another threshold, and filtering a region where extreme values greater than or equal to the threshold in the extreme value region R1 using a −6 dB method, the region where the extreme values of the extreme values region R1 is smaller than the threshold being not processed, so as to obtain a filtered extreme region R2; and
S05, merging the filtered extreme value regions R2 to obtain a final defect, which is recorded as F3, and measuring the final defect F3 to obtain final output data D, wherein the following steps are adopted for merging:
S51, firstly merging the regions having adjacent relationships in R2 for a first time to obtain suspected defects, which are recorded as F2; and
S52, merging the suspected defects F2 with a distance less than a set value for the second time to obtain final defect F3.
